(19) United States
(12) Patent Application Publication
(10) Pub. No.: US 2025/0070806 A1
(43) Pub. Date: Feb. 27, 2025

(54) Frequency Selective Digital Pre-Distortion Signal Generation

(71) Applicant: QUALCOMM Incorporated, San Diego, CA (US)

(72) Inventors: Yimu Tu, Newark, CA (US); Feng-Yu Lee, Zhubei (TW); Hao-Jen Cheng, San Jose, CA (US)

(21) Appl. No.: 18/454,740

(22) Filed: Aug. 23, 2023

(51) Int. Cl. H04B 1/04

(52) U.S. Cl. CPC H04B 1/0475; H04B 2001/0408

(57) ABSTRACT

This disclosure provides methods, components, devices and systems for signal generation. Some aspects more specifically relate to frequency-selective digital predistortion signal generation. In some examples, the method alters an input signal to produce a frequency-selected linear output signal of a power amplifier. For frequency-selective pre-distortion signal generation, a digital pre-distortion circuit suppresses the non-linear distortion at a specific band using Volterra kernels of a Volterra series model and a shiftable finite impulse response (FIR). The shiftable FIR can filter a particular portion of the signal's frequency, and the Volterra kernels can capture the non-linear memory effects of the input signals and output signals of the power amplifier. Upon refinement of the Volterra kernel coefficients, the Volterra series model can produce a compensation signal. The shiftable FIR can filter the compensation signal to produce a digital pre-distortion signal to input into the power amplifier for transmission.

### TECHNICAL FIELD

This disclosure relates generally to wireless communication, and more specifically, to employing frequency-selective digital pre-distortion signal generation to optimize signals broadcast at an edge of a spectrum to have greater transmit power.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

An AP can operate on various frequency bands, such as 2.4 GHz and 5 GHz, depending on the standard they support (e.g., 802.11b/g/n for 2.4 GHz and 802.11a/n/ac for 5 GHz). A frequency band can refer to a range of radio frequencies within the electromagnetic spectrum. It can be defined by two frequency values, typically the lower and upper-frequency limits. For example, the 2.4 GHz frequency band used in many wireless LANs spans from 2.400 GHz to 2.4835 GHz, covering a total bandwidth of 83.5 MHz.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for signal generation by a wireless station device. The method includes receiving an input signal at a signal path and evaluating a memory effect of the input signal on a Volterra series model. The method also includes adjusting Volterra kernel coefficients of the Volterra series model based at least in part on the memory effect and generating a compensation signal using the Volterra series model on the input signal. The method further includes generating a pre-distorted signal by applying a shiftable finite impulse response (FIR) to the compensation signal.

In some examples, the method includes transmitting the pre-distorted signal to a power amplifier and producing, by the power amplifier, an amplified output signal of the pre-distorted signal having a suppressed non-linear distortion at a specific band. The method also includes applying the amplified output signal to the Volterra series model and evaluating and updated memory effect of the amplified output signal on the Volterra series model. The method further includes adjusting the Volterra kernel coefficients of the Volterra series model based, at least in part, on the updated memory effect.

In some examples, the method includes evaluating the memory effect of the pre-distorted signal using the memory Volterra kernels when evaluating the memory effect.

In some examples, the shiftable FIR is programmed to filter lower out-of-band signal frequencies and to filter upper out-of-band signal frequencies associated with the input signal.

Another innovative aspect of the subject matter described in this disclosure can be implemented on a wireless station including one or more memories that store processor-executable code, and one or more processors coupled with the one or more memories and individually or collectively configured to, in association with executing the code, cause the wireless station to receive an input signal at a signal path and evaluate a memory effect of the input signal on a Volterra series model. The processor is operable to cause the wireless station to adjust Volterra kernel coefficients of the Volterra series model based at least in part on the memory effect and generate a compensation signal using the Volterra series model on the input signal. The processor is operable to cause the wireless station to generate a pre-distorted signal by applying a filter to the compensation signal.

An additional innovative aspect of the subject matter described in this disclosure can be implemented on a wireless access point including one or more memories that store processor-executable code, and one or more processors coupled with the one or more memories and individually or collectively configured to, in association with executing the code, cause the wireless station to receive an input signal at a signal path and evaluate a memory effect of the input signal on a Volterra series model. The processor is operable to cause the access point to adjust Volterra kernel coefficients of the Volterra series model based at least in part on the memory effect and generate a compensation signal using the Volterra series model on the input signal. The processor is operable to cause the access point to generate a pre-distorted signal by applying a filter to the compensation signal.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows examples of a power spectrum density of baseband equivalent of non-linear distortion, according to some aspects.

FIGS. 3A through 3C show examples of training and deployment of a digital predistortion module, according to some aspects.

FIGS. 4A through 4C show examples of frequency selective digital predistortions on out-of-band and in band signals.

FIG. 5 shows a flowchart illustrating an example process performable by a wireless access point that supports frequency selective digital predistortion of a signal, according to some aspects.

FIG. 6 shows a block diagram of an example wireless communication device that supports frequency selective digital predistortion of a signal, according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless transceivers and, more particularly, to performing frequency-selective digital pre-distortion signal generation. In some examples, the systems and methods described herein alter an input signal to produce a frequency-selected linear output signal of a power amplifier. For frequency-selective pre-distortion signal generation, a digital pre-distortion circuit suppresses the non-linear distortion at a specific band using Volterra kernels of a Volterra series model and a shiftable finite impulse response (FIR). The shiftable FIR can be programmed to filter a particular portion of the signal's frequency, and the Volterra kernels can capture the non-linear memory effects the input signals and output signals of the power amplifier have on the system. The resulting signals can be evaluated on an iterative basis to further refine the Volterra kernels to optimize the Volterra series model. Once refined, the Volterra series model produces a compensation signal. The shiftable FIR can filter the compensation signal to produce a digital pre-distortion signal to input into the power amplifier for transmission. As such, the resulting output signal of the power amplifier is linear on either the out-of-band sides or within the in-band of the signal.

Particular aspects of the subject matter described in this disclosure can be implemented to realize one or more of the following potential advantages. In some implementations, the present disclosure describes a device to generate output signals linearized on a frequency-selective basis for greater transmit power at the edge of a channel spectrum. Non-linear effects, or distortions, are introduced into a signal as voltage applied to a power amplifier is increased to produce a greater gain on the signal. By providing frequency-selective digital predistortion of the signal, aspects of the present disclosure may achieve greater signal strength at a band edge by linearizing the signal on the same side as the band edge to mitigate the distortion introduced by the power amplifier. Additionally, aspects of the present disclosure aim to optimize signals for different Modulation and Coding Scheme (MCS) rates. Factors such as Signal-to-Noise Ratio (SNR) and Bit Error Rate (BER) can be considered when deciding to mask, or disable, higher MCS rates, and factors such as Error Vector Magnitude (EVM) can be considered while utilizing lower MCS rates. As such, aspects of the disclosure can selectively linearize different portions of a signal to optimize the signal based on the factors being considered for a given MCS rate.

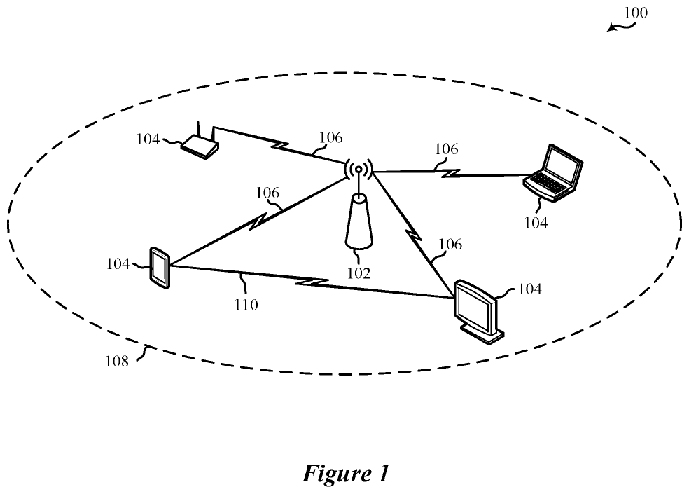

FIG. 1 shows a pictorial diagram of an example wireless communication network 100. According to some aspects, the wireless communication network 100 can be an example of a wireless local area network (WLAN) such as a WiFi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1. the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “WiFi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include WiFi Direct connections, connections established by using a WiFi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “WiFi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by WiFi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

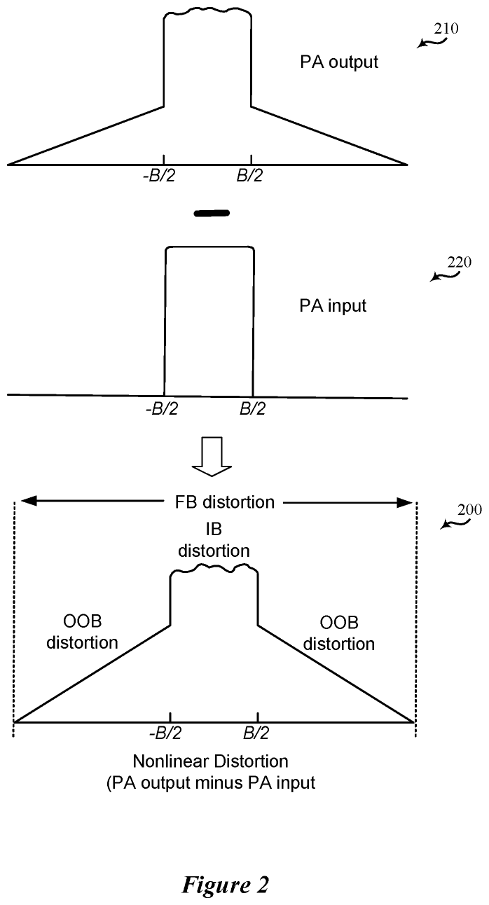

FIG. 2 shows an example of a power spectrum density (PSD) 200 of a baseband equivalent of a non-linear distortion. The PSD of a signal can be a measure that shows the strength of the variations (energy) as a function of frequency. In this example, the power amplifier (PA) input 220 has a bandwidth B. i.e., it occupies a frequency range of −B/2˜B/2. If the non-linear distortion is within −B/2˜B/2, the full-band (FB) non-linear distortion is divided into the in-band (IB) distortion and the out-of-band (OOB) distortion.

The IB distortion can degrade the error vector magnitude (EVM) and may deteriorate the link performance. The EVM can be suppressed at the transmitter side by a pre-compensation or the receiver side by a post-compensation. The OOB distortion, also known as spectral regrowth, can break the spectrum mask and interfere with adjacent channel communications. For modern communications (e.g., LTE, 5G-NR, WiFi), the OOB distortion is suppressed at the transmitter side to comply with communication specifications of adjacent channel power ratio (ACPR).

Digital predistortion (DPD), a pre-compensation technique with low complexity at the transmitter baseband, is an approach to suppress non-linear distortion. Conventional DPD techniques are FB linearization that is featured by simultaneously suppressing the IB and OOB distortions. The FB DPD has a fixed linearization objective. On the other hand, frequency-selective (FS) DPD focuses on suppressing the non-linear distortion at a specific band. FS DPD does not necessarily apply pre-distortion uniformly across the entire frequency band, but selectively, depending on the frequency content of the signal.

The FS DPD technique can be used in wireless systems where only specific components of the signal suffer from non-linear distortion or when some frequency components could introduce intermodulation distortion (IMD) in the critical bands. FS DPD can also be used in multi-band transmitters where each band may have different non-linear characteristics requiring different pre-distortion.

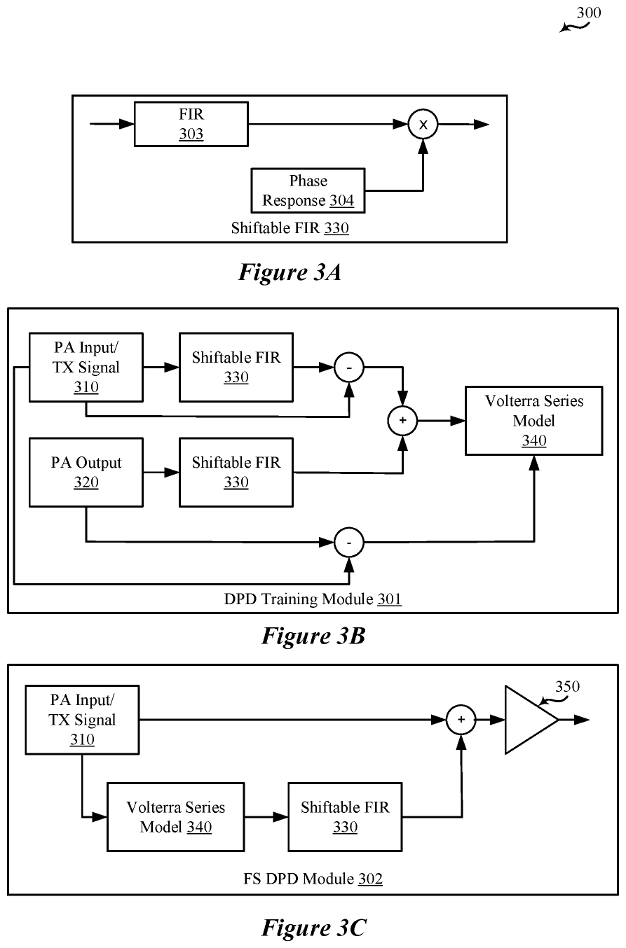

FIGS. 3A through 3C show elements representing digital pre-distortion training of a Volterra series model having selected Volterra kernels and the deployment of the trained Volterra series model for FS DPD signal generation. As shown in FIG. 3A, a shiftable finite impulse response (FIR) 330 includes a FIR 303 and a phase response 304. The shiftable FIR 330 can be configured to provide a cutoff frequency or center frequency that can be adjusted or “shifted” in real-time without having to redesign the filter or adjust the filter coefficients. The term “filter,” as used herein, includes a FIR (e.g., a programmable or shiftable FIR) filter and other suitable filters now known or subsequently developed.

As shown, the shiftable FIR 330 includes a FIR 303 that can operate as a type of digital filter for signal processing. As an example, the impulse response of the FIR 303 filter is “finite” because it settles to zero in a finite number of sample intervals, thereby producing no feedback. The output of the FIR 303 at any given time can be calculated solely from the current and previous input values. In some examples, the FIR 303 operates as described in Equation 1 shown below:

$$y ( n ) = {b}_{0} x ( n ) + {b}_{1} x ( n - 1 ) + {b}_{2} x ( n - 2 ) + … + {b}_{N} x ( n - N ) \qquad Equation 1$$

In Equation 1, y(n) represents the output of the FIR 303 at time n, x(n), x(n−1), . . . , x(n−N) represent the current and past input samples, and b₀, b₁, . . . , b_{N} by represent the filter coefficients that determine the characteristics of the FIR 303. The phase response 304 of the shiftable FIR 330 can provide a linear phase response to the input signal. A linear phase response can mean that all frequency components of the input signal are delayed by the same amount when passing through the shiftable FIR 330 so as to prevent phase distortion, which could potentially alter the shape of the signal.

FIG. 3B shows a DPD training module 301 for training a Volterra series model or kernels to generate a FS pre-distorted signal. The DPD training module 301 includes a power amplifier (PA) input 310 that is fed into a shiftable FIR 330, as described above. Additionally, the DPD training module 301 includes a PA output 320 fed into a second shiftable FIR 330 with the outputs of both shiftable FIRs 330 being fed into a Volterra series model 340 for training Volterra kernels.

The Volterra series model 340 can be a model for non-linear behavior that captures memory effects of the input. In some implementations, training the Volterra series model 340 can be defined using Equation 2 shown below:

$${c}_{1}^{′} ( {DPD}_{In} [ n ] + F \{ {PA}_{out} [ n ] - {DPD}_{In} [ n ] \} ) + {{c}_{2} ( {DPD}_{In} [ n ] + F \{ {PA}_{Out} [ n ] - {DPD}_{In} [ n ] \} )}^{2} = {PA}_{In} [ n ] - {PA}_{Out} [ n ] \qquad Equation 2$$

where c₁′ represents coefficients of the Volterra kernels of the Volterra series model 340, DPD_{In} represents the digital predistortion input, n represents the index of the iteration, F represents the shiftable FIRs 330, PA_{Out} represents the PA output 320, c₂ represents a second set of coefficients of the Volterra kernels of the Volterra series model 340 which can also be characterized as characteristics of the PA, and PAᵢₙ represents the PA input 310.

During training of the Volterra series model 340, Volterra kernels can be selected, and the order of the Volterra kernels can be determined during the design stage of the model based on the PA being used in a system. A Volterra series can be viewed as a functional power series expansion that represents the output of a non-linear system in terms of power of the input. This series expansion involves terms known as Volterra kernels. The order of a Volterra kernel can determine the interaction of the input history to the output. Examples of Volterra kernels include, but are not limited to, Zeroth-order Volterra kernels (h₀), First-order Volterra kernels (h₁), Second-order Volterra kernels (h₁), and Higher-order Volterra kernels (h₃[m1, m₂, m₃]). For instance, the zeroth-order Volterra kernel can represent a constant term representing the output of a system when the input is zero. In other words, the zeroth-order Volterra kernel can correspond to the initial output of a system or bias. Thus, selecting the Volterra kernels establishes the Volterra series model 340 to generate the FS pre-distorted signal by using a single model.

Also, during initialization, the shiftable FIRs 330 can be programmed such that the center frequency or cutoff frequency of the filter are set. This can be performed in real-time, allowing for dynamic adjustments to the shiftable FIRs 330. Based on the intended application, the shiftable FIRs 330 can be programmed to remove unwanted OOB or IB frequencies from a signal or selectively amplify certain frequencies. By programming the shiftable FIRs 330, this sets the F function as described in equation 2.

Once initialized, a pre-distorted signal (e.g., a WiFi signal) can be introduced to the DPD training module 301 and used as the PA input 310. The pre-distorted signal can also be used to derive the PA output 320. In some examples, the PA output 320 may be collected with DPD off in the initialization stage by a loopback circuit. Using the exemplary equation 2, terms DPD_{In}[n], PA_{Out}[n], PA_{In}[n] may be defined. The pre-distorted signal can be applied, as shown in equation 2, and the memory effects of the signal on the Volterra series model 340 can be evaluated. As discussed, memory effects can be captured by the Volterra kernels. Each Volterra kernel selected for the Volterra series model 340 can represent the contribution of a particular interaction of the input history to the output. For instance, first-order Volterra kernels can represent the memory effect of single points in the past. This can be similar to an impulse response in a linear system, describing how an impulse at a certain past time point affects the current output. In another instance, second-order Volterra kernels can represent the memory effect of pairs of points in the past. The memory effect of the second-order Volterra kernels can describe how the product of the input at two different past time points contributes to the current output. In other words, the second-order Volterra kernels can capture second-order non-linearities and memory effects, such as intermodulation distortion and gain compression or expansion.

Based, at least in part, on the evaluated memory effects, the Volterra series coefficients (e.g., c₁′, c₂) can be initially set. The Volterra series coefficients can determine the behavior and response of a system as described by the Volterra series model 340. The Volterra series coefficients can also determine the contributions of the input or inputs at various points in time to the output of the system. As an example, a zeroth-order coefficient of a zeroth-order Volterra kernel can be a scalar value that can represent the output of a system when the input is zero providing the bias or baseline output of the system. As another example, a second-order coefficient of a second-order Volterra kernel can account for the response of the system to an interaction of the input signal (e.g., WiFi signal) with itself at different time lags. This can include non-linear effects like amplitude modulation and intermodulation distortion.

Using the defined Volterra coefficients, the signal, and derived output signal, and the programmed shiftable FIRS 330, a pre-distorted signal (e.g., WiFi output signal) can be produced by the Volterra series model 340. In some examples, the output signal can be defined as show in equation 3 below:

$${DPD}_{out} [ n ] = F \{ {c}_{1}^{′} ( {DPD}_{In} [ n ] ) + {{c}_{2} ( {DPD}_{In} [ n ] )}^{2} + {DPD}_{In} \qquad Equation 3$$

where DPD_{Out} represents the digital pre-distorted output, c₁′ represents coefficients of the Volterra kernels of the Volterra series model 340, DPD_{In} represents the digital pre-distortion input, n represents the index of the iteration, F represents the shiftable FIRs 330, and c₂ represents a second set of coefficients of the Volterra kernels of the Volterra series model 340.

The produced digital pre-distorted output signal can be sent to the PA for amplification. For iterative training, the amplified signal can be used as a new digital pre-distorted input, PA input, and PA output. From that, the memory effects of the signal on the Volterra series model 340 can be reevaluated. The iterative process refines the Volterra coefficients such that after K iterations, the PA output 320 is close to the ideal pre-distorted signal.

As an example of the iterative process on the FS Volterra series model 340, a measurement can be taken of the output signal of the PA using the inputted pre-distorted output signal. A comparison can be performed that compares the output signal of the PA with the inputted signal to calculate the error. The error signal can represent the distortion introduced by the PA. The error signal can then be used to update the Volterra coefficients. This can be done in a way that reduces the error when the updated Volterra coefficients are used. In this iterative learning approach, the error signal is evaluated after each iteration of the signal produced by Volterra series model 340 until the PA output is considered ideal with minimal error. In some implementations, the iterative learning control approach is performed using the Least Mean Squares (LMS) or Recursive Least Squares (RLS) algorithms, which can iteratively adjust the Volterra kernels to minimize the mean square error.

By using the iterative learning control approach, the Volterra coefficients are gradually adjusted to achieve the desired pre-distortion. In some implementations, the iterations continue such that the Volterra series model 340 can accurately compensate for the non-linearities and memory effects of the PA, thus improving the overall signal quality and system performance on a FS-basis.

FIG. 3C shows FS DPD module 302 that generate a FS pre-distorted signal. The FS DPD module 302 includes a PA input 310 (e.g., a WiFi signal), the trained Volterra series model 340 that produces pre-distortion using Volterra kernels, and a shiftable FIR 330, as described above. In some implementations, the FS DPD module 302 can be defined using Equation 4 as shown:

$${DPD}_{Out} [ n ] = F \{ {c}_{1}^{′} ( {DPD}_{In} [ n ] ) + {{c}_{2} ( {DPD}_{In} [ n ] )}^{2} \} + {DPD}_{In} \qquad Equation 4$$

where DPD_{Out} represents the output of the PA 350, c₁′ represents coefficients of the Volterra kernels of the Volterra series model 340, DPD_{In} represents the digital predistortion input, n represents the index of the iteration, F represents the shiftable FIR 330, and c₂ represents a second set of coefficients of the Volterra kernels of the Volterra series model 340.

Upon deployment, the shiftable FIR 330 filter is designed according to the requirement on the target DPD linearization band. For example, the shiftable FIR 330 can be programmed to filter OOB or IB band frequencies based on a transmission on a band edge. Specifically, the frequency range of the target DPD band can be identical to the pass-band frequency of the coefficient vector of the shiftable FIR 330. By specifying the pass-band frequency range, the FS DPD module 302 can focus on suppressing the non-linear distortion at an arbitrary band. As an example, assume the coefficient vector is a high pass filter with a cutoff frequency of B/2, the FS DPD module 302 can then focus on suppressing the OOB distortion.

In some implementations, the Volterra series model 340 can be a trained model as described in 3B where PA input samples and reconstructed PA output samples are used to extract and refine the Volterra coefficients of the Volterra series model 340. Those Volterra coefficients can be extracted and directly copied to the Volterra series model 340 to form the FS DPD module 302. After model configuration, the FS DPD module 302 can be enabled to conduct FS DPD to focus on suppressing the distortion at the target band that is determined by a pass-band frequency range. In some implementations, the PA input 310 and the corresponding output of the PA 350 (DPD_{Out}[n]) can be used to iteratively update the Volterra coefficients of the Volterra series model 340 in a similar fashion as described by the DPD training module 301.

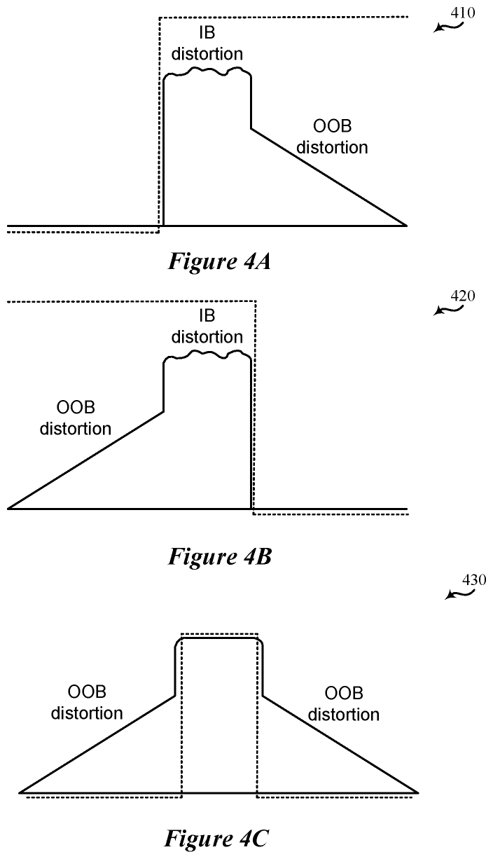

FIGS. 4A through 4C show exemplary frequency filtering configurations performable by the FS DPD module 302. As shown in FIG. 4A, the OOB distortion is suppressed on the left side of the FB distortion producing a partial-band pre-compensation 410, where the target pre-compensation band is identical to the pass-band frequency range of the shiftable FIR being used. Similarly, in FIG. 4B, the OOB distortion is suppressed on the right of the FB distortion producing another partial-band pre-compensation output 420.

As shown in FIG. 4C, in some implementations, the FS DPD module 302 can be used as a band-limited DPD that focuses on suppressing the IB distortion. In such instances, the shiftable FIR can be used as a low-pass filter. For IB distortion suppression, the first-order Volterra kernel can be modified during training to filter IB distortions allowing for suppression of the IB distortion.

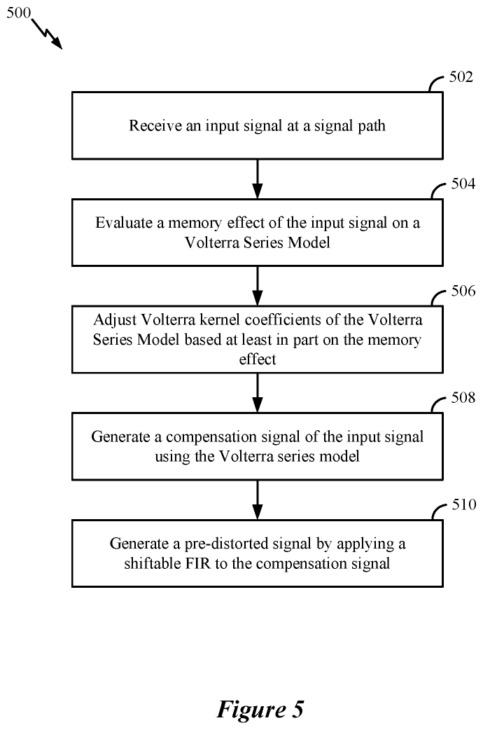

FIG. 5 shows a flowchart illustrating an example process 500 performable by or at a wireless AP that supports frequency-selective digital pre-distortion signal generation, according to some aspects. The wireless AP may be, for example, AP 102 discussed above with reference to FIG. 1, or another wireless AP.

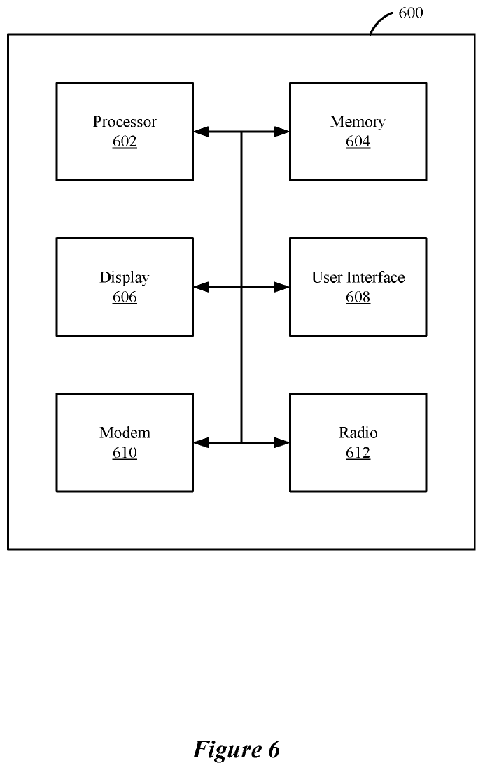

The operations of the process 500 may be implemented by a wireless AP or its components as described herein. For example, the process 500 may be performed by a wireless communication device, such as the wireless communication device 600 described with reference to FIG. 6, operating as or within a wireless AP. In some examples, the process 500 may be performed by a wireless AP such as one of the APs 102 described with reference to FIG. 1.

At block 502, a transceiver of the AP may receive an input signal at a signal path. In some example, the input signal is a wireless packet preparing for transmission along channel at a spectrum edge. In some examples, the spectrum edge includes restrictions on wireless transmission at the edge of the band.

At block 504, the input signal is applied to a Volterra series model, and the memory effect of the input signal may be evaluated on the Volterra series model. In some examples, the evaluation of the memory effect can be performed by analyzing Volterra kernels of different order and delays that are associated with the Volterra series model. As an example, first-order Volterra kernels can represent the linear response of the system. The length or span of the first-order kernel can indicate the memory depth of the linear part of the system. As another example, second-order Volterra kernels can represent non-linear effect of the system. The second-order kernels can provide insights into non-linear memory effects, such as intermodulation distortions that depend on inputs at two different times. Another practice in evaluating memory effect can involve plotting the Volterra kernels. Visual representations can provide a sense of the memory depth and the strength of the non-linear effects. For example, if a second order Volterra kernel has significant values over a wide range of time lags, it can indicate strong non-linear memory effects over those time lags. In some implementations, the Volterra series model can be truncated to a certain order and memory depth. The evaluation of the memory effect can involve evaluating the goodness-of-fit of the truncated model against actual system outputs. It should be noted that the memory depth of the system can be roughly indicated by how far back in time the Volterra kernels have significant value. If higher-order Volterra kernels have values that span a longer duration than the first-order kernel, it can suggest that non-linear memory effects persist for longer periods.

At block 506, Volterra kernel coefficients of the Volterra series model can be adjusted based, at least in part, on the memory effect. When refining a Volterra series model, in the context of the memory effect, the goal can be to obtain an accurate representation of the behavior of the system over time, both in terms of its non-linearities and its memory. The Volterra kernel coefficients can capture these effects. The memory effect can mean that the output of the system at any given time can be influenced by several previous inputs and not just the current input. The span and values of the coefficients in the Volterra kernels can be adjusted to accurately capture these effects over the necessary duration. For instance, if a system has a strong memory effect that lasts for five units of time, the Volterra kernels should have significant coefficients over that span.

As discussed, first-order Volterra kernels represent linear responses of the system, second-order and higher-order kernels capture non-linear interactions between inputs at different times. If memory effects play a role in these non-linear interactions, the coefficients of these higher-order kernels can be adjusted to capture such behaviors. In some implementations, the error between the Volterra series model's predicted output and the actual system output can be used to adjust the Volterra kernel coefficients. If the Volterra series model is not adequately capturing memory effects, this can appear as a significant error in predictions, prompting the need to adjust the Volterra kernel coefficients. In some implementations, regularization techniques can be applied to avoid overfitting. The regularization techniques can penalize overly complex models and help in obtaining a balanced model that can capture memory effects without overfitting to noise.

At block 508, the Volterra series model generates a compensation signal of the input signal using the Volterra series model. The compensation signal can be a signal crafted to counteract or compensate for the unwanted non-linearities and memory effects of the system. In this instance, based on the frequency selection, the compensation can be crafted to compensate for either side of the OOB or IB range. As an example, a PA can exhibit non-linear behavior when amplifying an input signal. Non-linearities can lead to signal distortion and interference with adjacent channels. In some implementations, the Volterra series model is inverted. By driving the system with an inverted model, the compensation signal can be linearized. This inversion process can result in a compensation signal that, when applied to the input signal and fed into the PA, can counteract the non-linearities of the PA. As such, the compensation signal produced by the Volterra series model can be designed to negate undesired effects of the inherent non-linearity and memory produced by the PA when amplifying the input signal.

At block 510, the compensation signal can be fed into a shiftable FIR dynamically programmed to limit a particular width and location of a signal to generate a pre-distorted signal. Passing the compensation signal through the shiftable FIR filter may filter out the undesired frequency components. After passing the compensation signal through the shiftable FIR filter, the resulting pre-distorted signal, which has been adjusted for optime time and or phase alignment, can be added to the input signal and fed into a PA. As a result, the output signal can be more linear and free from distortions on a frequency-selected basis that would otherwise be present due to its inherent non-linearities and memory effects.

In some implementations, the output signal produced by the PA can be applied to the Volterra series model and the updated memory effect of that signal can be evaluated. Based on the updated memory effect, the Volterra kernel coefficients can be readjusted and refined to further optimize the performance of the Volterra series model. This process can be repeated in an iterative manner using the output signals and information from previous repetitions (or iterations) of the FS DPD module to improve the performance of the Volterra series model and the overall performance of the system. In other words, iterative learning control can be utilized by the system, such that it leverages the repetitive nature of the FS DPD to iteratively refine the input signals, thus minimizing the error and improving system performance over time. This iterative process can assist in refining non-linearities and memory effects, as described by the Volterra series model.

FIG. 6 shows a block diagram of an example wireless communication device 600 that supports frequency-selective digital pre-distortion of a signal, according to some aspects of the present disclosure. In some examples, the wireless communication device 600 is configured or operable to perform all or part of the process 500 described with reference to FIG. 5. In various examples, the wireless communication device 600 can be a chip, SoC, chipset, package or device that may include: one or more modems (such as a WiFi modem or a cellular modem such as 3GPP 4G LTE or 5G compliant modem); one or more processors, processing blocks or processing elements (collectively “the processor” 602); one or more radios (collectively “the radio” 612); and one or more memories or memory blocks (collectively “the memory” 604).

The wireless communication device 600 includes a processor component 602, a memory component 604, and display component 606, a user interface component 608, a modem component 610, and a radio component 612. Portions of one or more of the components 606, 608, 610, and 612 may be implemented at least in part in hardware or firmware. In some examples, at least some of the components 606, 608, 610, and 612 of the device 600 are implemented at least in part by a processor and as software stored in a memory. For example, portions of one or more of the display component 606, the user interface component 608, and the modem component 610 can be implemented as non-transitory instructions (or “code”) executable by the processor 602 to perform the functions or operations of the respective module.

In some implementations, the processor 602 may be a component of a processing system. A processing system may generally refer to a system or series of machines or components that receives inputs and processes the inputs to produce a set of outputs (which may be passed to other systems or components of, for example, the wireless communication device 600). For example, a processing system of the device 600 may refer to a system including the various other components or subcomponents of the device 600, such as the processor, or a transceiver, or a communications manager, or other components or combinations of components of the device 600. The processing system of the device 600 may interface with other components of the device 600 and may process information received from other components (such as inputs or signals) or output information to other components. For example, a chip or modem of the device 600 may include a processing system, a first interface to output information and a second interface to obtain information. In some implementations, the first interface may refer to an interface between the processing system of the chip or modem and a transmitter, such that the device 600 may transmit information output from the chip or modem. In some implementations, the second interface may refer to an interface between the processing system of the chip or modem and a receiver, such that the device 600 may obtain information or signal inputs, and the information may be passed to the processing system. A person having ordinary skill in the art will readily recognize that the first interface also may obtain information or signal inputs, and the second interface also may output information or signal outputs.

The processor 602 is capable of, configured to, or operable to processes information received through the radio 612 and the modem 610, and processes information to be output through the modem 610 and the radio 612 for transmission through the wireless medium. The processor 602 may perform logical and arithmetic operations using program instructions stored within the memory 604. The instructions in the memory 604 may be executable (by the processor 602, for example) to implement the methods described herein. In some examples, the processor 602, together with the memory 604, are capable of, configured to, or operable to: receive an input signal at a signal path; evaluate a memory effect of the input signal on a Volterra series model; adjust Volterra kernel coefficients of the Volterra series model based at least in part on the memory effect; generate a compensation signal using the Volterra series model on the input signal; and generate a pre-distorted signal by applying a shiftable finite impulse response (FIR) to the compensation signal.

The memory 604 is capable of, configured to, or operable to store and communicate instructions and data to and from the processor 602.

The user interface 608 may be any device that allows a user to interact with the wireless communication device 600, such as a keyboard, a mouse, a microphone, et cetera. In aspects, the user interface 608 may be integrated with the display component 606 to present a touchscreen.

The modem 610 is capable of, configured to, or operable to modulate packets and to output the modulated packets to the radio 612 for transmission over the wireless medium. The modem 610 is similarly configured to obtain modulated packets received by the radio 612 and to demodulate the packets to provide demodulated packets.

The radio 612 includes at least one radio frequency transmitter and at least one radio frequency receiver, which may be combined into one or more transceivers. The transmitter(s) and receiver(s) may be coupled to one or more antennas. In some aspects, the processor 602, the memory 604, the modem 610, and the radio 612 may collectively facilitate the wireless communication of the wireless communication device 600 with other wireless communication devices over multiple frequency bands (such as 2.4 GHz, 5 GHz, or 6 GHz).

In some examples, the wireless communication device 600 can be a device for use in an AP, such as the AP 102 described with reference to FIG. 1, or another suitable AP. In some other examples, the wireless communication device 600 can be an AP that includes such a chip, SoC, chipset, package or device as well as multiple antennas. The wireless communication device 600 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE family of wireless communication protocol standards. In some examples, the wireless communication device 600 also includes or can be coupled with an application processor which may be further coupled with another memory. In some examples, the wireless communication device 600 further includes at least one external network interface that enables communication with a core network or backhaul network to gain access to external networks including the Internet.

In some examples, the wireless communication device 600 can be a device for use in a STA, such one the STA 104 described with reference to FIG. 1, or another suitable STA. In some other examples, the wireless communication device 600 can be a STA that includes such a chip, SoC, chipset, package, or device as well as multiple antennas. The wireless communication device 600 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 1302.13 family of wireless communication protocol standards. In some examples, the wireless communication device 600 also includes or can be coupled with an application processor which may be further coupled with another memory. In some examples, the wireless communication device 600 further includes a user interface (UI) (such as a touchscreen or keypad) and a display, which may be integrated with the UI to form a touchscreen display. In some examples, the wireless communication device 600 may further include one or more sensors such as, for example, one or more inertial sensors, accelerometers, temperature sensors, pressure sensors, or altitude sensors.

Implementation examples are described in the following numbered clauses:
1. A method of performing signal generation, the method including:
   receiving an input signal at a signal path;
   evaluating a memory effect of the input signal on a Volterra series model;
   adjusting Volterra kernel coefficients of the Volterra series model based at least in part on the memory effect;
   generating a compensation signal using the Volterra series model on the input signal; and
   generating a pre-distorted signal by applying a shiftable finite impulse response (FIR) to the compensation signal.
2. The method of clause 1, where evaluating the memory effect includes evaluating the memory effect of the pre-distorted signal using the Volterra kernels.
3. The method of clause 1 or 2, where the shiftable FIR is programmed to filter lower out-of-band signal frequency distortions associated with the input signal.
4. The method of clause 1, 2, or 3, where the shiftable FIR is programmed to filter upper out-of-band signal frequency distortions associated with the input signal.
5. The method of clause 1, 2, 3, or 4, where the shiftable FIR is programmed to filter in-band signal frequency distortions associated with the input signal.
6. The method of clause 1, 2, 3, 4, or 5, where the input signal and an output signal produced by a power amplifier amplifying the input signal are used to evaluate the memory effect.
7. The method of c clause 1, 2, 3, 4, 5, or 6, where the Volterra kernels of the Volterra series model are selected based at least in part on a power amplifier amplifying the pre-distorted signal.
8. The method of clause 1, 2, 3, 5, 6, or 7, further including:
   transmitting the pre-distorted signal to a power amplifier; and
   producing, by the power amplifier, an amplified output signal of the pre-distorted signal having a suppressed non-linear distortion at a specific band.
9. The method of clause 1, 2, 3, 4, 5, 6, 7, or 8, further including:
   transmitting the pre-distorted signal to a power amplifier;
   producing, by the power amplifier, an amplified output signal of the pre-distorted signal having a suppressed non-linear distortion at a specific band;
   applying the amplified output signal to the Volterra series model;
   evaluating and updated memory effect of the amplified output signal on the Volterra series model; and
   adjusting the Volterra kernel coefficients of the Volterra series model based at least in part on the updated memory effect.
10. The method of clause 1, 2, 3, 4, 5, 6, 7, 8, or 9, where the input signal is a wireless packet.
11. A wireless station including:
   one or more memories that store processor-executable code; and
   one or more processors coupled with the one or more memories and individually or collectively configured to, in association with executing the code, cause the wireless station to:
      receive an input signal at a signal path;
      evaluate a memory effect of the input signal on a Volterra series model;
      adjust Volterra kernel coefficients of the Volterra series model based at least in part on the memory effect;
      generate a compensation signal using the Volterra series model on the input signal; and
      generate a pre-distorted signal by applying a filter to the compensation signal.
12. The wireless station of clause 11, where evaluating the memory effect includes evaluating the memory effect of the pre-distorted signal using the Volterra kernels.
13. The wireless station of clause 11 or 12, where the filter is programmed to filter lower out-of-band signal frequency distortions associated with the input signal.
14. The wireless station of clause 11, 12, or 13, where the filter is programmed to filter upper out-of-band signal frequency distortions associated with the input signal.
15. The wireless station of clause 11, 12, 13, or 14 where the filter is programmed to filter in-band signal frequency distortions associated with the input signal.
16. The wireless station of clause 11, 12, 13, 14, or 15, where the input signal and an output signal produced by a power amplifier amplifying the input signal are used to evaluate the memory effect.
17. The wireless station of clause 11, 12, 13, 14, 15, or 16, where the Volterra kernels of the Volterra series model are selected based at least in part on a power amplifier amplifying the pre-distorted signal.
18. The wireless station of clause 11, 12, 13, 14, 15, 16, or 17, where the processor-executable code further causes the wireless station to:
   transmit the pre-distorted signal to a power amplifier; and
   produce, by the power amplifier, an amplified output signal of the pre-distorted signal having a suppressed non-linear distortion at a specific band.
19. The wireless station of clause 11, 12, 13, 14, 15, 16, 17, or 18, wherein the processor-executable code further causes the wireless station to:
   transmit the pre-distorted signal to a power amplifier;
   produce, by the power amplifier, an amplified output signal of the pre-distorted signal having a suppressed non-linear distortion at a specific band;
   apply the amplified output signal to the Volterra series model;
   evaluate and updated memory effect of the amplified output signal on the Volterra series model; and
   adjust the Volterra kernel coefficients of the Volterra series model based at least in part on the updated memory effect.
20. The method of clause 11, 12, 13, 14, 15, 16, 17, 18, or 19 where the input signal is a wireless packet.
21. A wireless access point including:
   one or more processors; and
   one or more memories coupled with the one or more processors and that store processor-executable code that, when executed by the one or more processors, is configured to cause the wireless access point to:
      receive an input signal at a signal path;
      evaluate a memory effect of the input signal on a Volterra series model;
      adjust Volterra kernel coefficients of the Volterra series model based at least in part on the memory effect;
      generate a compensation signal using the Volterra series model on the input signal; and
      generate a pre-distorted signal by applying a filter to the compensation signal.
22. The wireless access point of clause 21, where evaluating the memory effect includes evaluating the memory effect of the pre-distorted signal using the Volterra kernels.
23. The wireless access point of clause 21 or 22, where the filter is programmed to filter lower out-of-band signal frequency distortions associated with the input signal.
24. The wireless access point of clause 21, 22, or 23 where the filteris programmed to filter upper out-of-band signal frequency distortions associated with the input signal.
25. The wireless access point of clause 21, 22, 23, or 24, where the filter is programmed to filter in-band signal frequency distortions associated with the input signal.
26. The wireless access point of clause 21, 22, 23, 24, or 25, where the input signal and an output signal produced by a power amplifier amplifying the input signal are used to evaluate the memory effect.
27. The wireless access point of clause 21, 22, 23, 24, 25, or 26, where the Volterra kernels of the Volterra series model are selected based at least in part on a power amplifier amplifying the pre-distorted signal.
28. The wireless access point of clause 21, 22, 23, 24, 25, 26, or 27, where the processor-executable code further causes the wireless access point to:
   transmit the pre-distorted signal to a power amplifier; and
   produce, by the power amplifier, an amplified output signal of the pre-distorted signal having a suppressed non-linear distortion at a specific band.
29. The wireless access point of clause 21, 22, 23, 24, 25, 26, 27, or 28, where the processor-executable code further causes the wireless access point to:
   transmit the pre-distorted signal to a power amplifier;
   produce, by the power amplifier, an amplified output signal of the pre-distorted signal having a suppressed non-linear distortion at a specific band;
   apply the amplified output signal to the Volterra series model;
   evaluate and updated memory effect of the amplified output signal on the Volterra series model; and
   adjust the Volterra kernel coefficients of the Volterra series model based at least in part on the updated memory effect.
30. The wireless access point of clause 21, 22, 23, 24, 25, 26, 27, 28, or 29, where the input signal is a wireless packet.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with.” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method of performing signal generation, the method comprising:
receiving an input signal at a signal path;
evaluating a memory effect of the input signal on a Volterra series model;
adjusting Volterra kernel coefficients of the Volterra series model based at least in part on the memory effect;
generating a compensation signal using the Volterra series model on the input signal; and
generating a pre-distorted signal by applying a shiftable finite impulse response (FIR) to the compensation signal.

2. The method of claim 1, wherein evaluating the memory effect includes evaluating the memory effect of the pre-distorted signal using Volterra kernels of the Volterra series model.

3. The method of claim 1, wherein the shiftable FIR is programmed to filter lower out-of-band signal frequency distortions associated with the input signal.

4. The method of claim 1, wherein the shiftable FIR is programmed to filter upper out-of-band signal frequency distortions associated with the input signal.

5. The method of claim 1, wherein the shiftable FIR is programmed to filter in-band signal frequency distortions associated with the input signal.

6. The method of claim 1, wherein the input signal and a reconstructed output signal associated with the input signal are used to evaluate the memory effect.

7. The method of claim 1, wherein Volterra kernels of the Volterra series model are selected based, at least in part, on a power amplifier amplifying the pre-distorted signal.

8. The method of claim 1, further comprising:
transmitting the pre-distorted signal to a power amplifier; and
producing, by the power amplifier, an amplified output signal of the pre-distorted signal having a suppressed non-linear distortion at a specific band.

9. The method of claim 1, further comprising:
transmitting the pre-distorted signal to a power amplifier;
producing, by the power amplifier, an amplified output signal of the pre-distorted signal having a suppressed non-linear distortion at a specific band;
applying the amplified output signal to the Volterra series model;
evaluating and updated memory effect of the amplified output signal on the Volterra series model; and
adjusting the Volterra kernel coefficients of the Volterra series model based, at least in part, on the updated memory effect.

10. The method of claim 1, wherein the input signal is a wireless packet.

11. A wireless station comprising:
one or more memories that store processor-executable code; and
one or more processors coupled with the one or more memories and individually or collectively configured to, in association with executing the code,
cause the wireless station to:
receive an input signal at a signal path;
evaluate a memory effect of the input signal on a Volterra series model;
adjust Volterra kernel coefficients of the Volterra series model based at least in part on the memory effect;
generate a compensation signal using the Volterra series model on the input signal; and
generate a pre-distorted signal by applying a filter to the compensation signal.

12. The wireless station of claim 11, wherein evaluating the memory effect includes evaluating the memory effect of the pre-distorted signal using Volterra kernels.

13. The wireless station of claim 11, wherein the filter is programmed to filter lower out-of-band signal frequency distortions associated with the input signal.

14. The wireless station of claim 11, wherein the filter is programmed to filter upper out-of-band signal frequency distortions associated with the input signal.

15. The wireless station of claim 11, wherein the filter is programmed to filter in-band signal frequency distortions associated with the input signal.

16. The wireless station of claim 11, wherein the input signal and a reconstructed output signal associated with the input signal are used to evaluate the memory effect.

17. The wireless station of claim 11, wherein Volterra kernels of the Volterra series model are selected based, at least in part, on a power amplifier amplifying the pre-distorted signal.

18. The wireless station of claim 11, further comprising:
transmitting the pre-distorted signal to a power amplifier; and
producing, by the power amplifier, an amplified output signal of the pre-distorted signal having a suppressed non-linear distortion at a specific band.

19. The wireless station of claim 11, further comprising:
transmitting the pre-distorted signal to a power amplifier;
producing, by the power amplifier, an amplified output signal of the pre-distorted signal having a suppressed non-linear distortion at a specific band;
applying the amplified output signal to the Volterra series model;
evaluating and updated memory effect of the amplified output signal on the Volterra series model; and
adjusting the Volterra kernel coefficients of the Volterra series model based, at least in part, on the updated memory effect.

20. The method of claim 1, wherein the input signal is a wireless packet.

21. A wireless access point comprising:
one or more processors; and
one or more memories coupled with the one or more processors and that store processor-executable code that, when executed by the one or more processors, is configured to cause the wireless access point to:
receive an input signal at a signal path;
evaluate a memory effect of the input signal on a Volterra series model;
adjust Volterra kernel coefficients of the Volterra series model based, at least in part, on the memory effect;
generate a compensation signal using the Volterra series model on the input signal; and
generate a pre-distorted signal by applying a filter to the compensation signal.

22. The wireless access point of claim 21, wherein evaluating the memory effect includes evaluating the memory effect of the pre-distorted signal using Volterra kernels of the Volterra series model.

23. The wireless access point of claim 21, wherein the filter is programmed to filter lower out-of-band signal frequency distortions associated with the input signal.

24. The wireless access point of claim 21, wherein the filter is programmed to filter upper out-of-band signal frequency distortions associated with the input signal.

25. The wireless access point of claim 21, wherein the filter is programmed to filter in-band signal frequency distortions associated with the input signal.

26. The wireless access point of claim 21, wherein the input signal and an output signal produced by a power amplifier amplifying the input signal are used to evaluate the memory effect.

27. The wireless access point of claim 21, wherein the Volterra kernels of the Volterra series model are selected based, at least in part, on a power amplifier amplifying the pre-distorted signal.

28. The wireless access point of claim 21, wherein the processor-executable code further causes the wireless access point to:
transmit the pre-distorted signal to a power amplifier; and
produce, by the power amplifier, an amplified output signal of the pre-distorted signal having a suppressed non-linear distortion at a specific band.

29. The wireless access point of claim 21, wherein the processor-executable code further causes the wireless access point to:
transmit the pre-distorted signal to a power amplifier;
produce, by the power amplifier, an amplified output signal of the pre-distorted signal having a suppressed non-linear distortion at a specific band;
apply the amplified output signal to the Volterra series model;
evaluate and updated memory effect of the amplified output signal on the Volterra series model; and
adjust the Volterra kernel coefficients of the Volterra series model based, at least in part, on the updated memory effect.

30. The wireless access point of claim 21, wherein the input signal is a wireless packet.
